(19) United States
(12) Patent Application Publication
(10) Pub. No.: US 2018/0174206 A1
(43) Pub. Date: Jun. 21, 2018

(54) SYSTEM FOR AUTOMATING UPDATING INVENTORY PRICING AND ADVERTISEMENTS

(71) Applicant: WEBNET SERVICES, INC., Somers, NY (US)

(72) Inventors: Steven P. COUTURE, Somers, NY (US); Douglas FLOSS, Naples, FL (US)

(73) Assignee: WEBNET SERVICES, INC., Somers, NY (US)

(21) Appl. No.: 15/850,418

(22) Filed: Dec. 21, 2017

Related U.S. Application Data
(60) Provisional application No. 62/437,522, filed on Dec. 21, 2016.

(51) Int. Cl. G06Q 30/02; G06Q 10/08

(52) U.S. Cl. CPC G06Q 30/0283; G06Q 10/087; G06Q 30/0277

(57) ABSTRACT

A computerized system for synchronously adjusting pricing displayed in online advertisements, comprising: a pricing logic module configured to determine a price for an item based on inputs, the pricing logic module configured to receive the information from at least one of an external dealer, manufacturer, and marketing service; and a deal investigator module configured to receive information from the dealer, the deal investigator module being configured to sort the information received from the dealer and to send the information to the pricing logic module, the system being configured to synchronously update pricing in online advertisements based on a price determined by the pricing logic module.

### CROSS REFERENCE TO RELATED APPLICATIONS

The present application claims the benefit of and priority to U.S. Prov. App. Ser. No. 62/437,522 filed Dec. 21, 2016, the contents of which is hereby incorporated herein in its entirety.

### FIGURE SELECTED FOR PUBLICATION

FIG. 9

### BACKGROUND OF THE INVENTION

### Field of the Invention

The present invention relates generally to an inventory management and pricing system.

### Description of the Related Art

Cars sold at car dealerships each have a different price depending on a variety of factors including those intrinsic to the vehicle such as particular options and those extrinsic to the vehicle such as market demand, interest rates, and various incentive programs offered by the manufacturer and/or other dealers.

Given the many factors involved in pricing a vehicle, there exists a need to update pricing for vehicles in a dealership which can be based on variety of collected information and a system that can automatically update the various advertisements published for particular vehicles in a multitude of advertising channels.

### ASPECTS AND SUMMARY OF THE INVENTION

The present invention relates to a system and method for determining pricing of inventory based on a plurality of information sorted and collected from various sources including individual dealers, manufactures and marketing services.

A computerized system for synchronously adjusting pricing displayed in online advertisements, may include: a pricing logic module configured to determine a price for an item based on inputs, the pricing logic module configured to receive the information from at least one of an external dealer, manufacturer, and marketing service; and a deal investigator module configured to receive information from the dealer, the deal investigator module being configured to sort the information received from the dealer and to send the information to the pricing logic module, the system being configured to synchronously update pricing in online advertisements based on a price determined by the pricing logic module.

The deal investigator module may be configured to: import a dealer's vehicle inventory data; import a manufacturer's finance rates, lease rates and residuals, and rebates and incentives; and identify vehicle characteristics based on a VIN number such that vehicles having predetermined characteristics are sorted into groups. The pricing logic module may be configured to: determine a customized price for each vehicle based on predetermined rules; apply at least one of current finance rates, lease rates, manufacturer rebates and incentives to each vehicle; and create special payment offers.

In an embodiment, a server for automatically updating a plurality of ads associating with an ad campaign may include a memory and at least one processor operatively coupled to the memory, configured to: detect a change in an ad from an ad campaign including a plurality of ads; and in response to detecting the change in the ad, effect the change in all of the ads. Further, the processor may be configured to validate user credentials associating with the ad campaign for an online advertising service hosing the ad campaign such that the changes may be effected automatically.

The above and other aspects, features and advantages of the present invention will become apparent from the following description read in conjunction with the accompanying drawings, in which like reference numerals designate the same elements.

### BRIEF DESCRIPTION OF THE DRAWINGS

A further understanding of the present invention can be obtained by reference to a preferred embodiment set forth in the illustrations of the accompanying drawings. Although the illustrated preferred embodiment is merely exemplary of methods, structures and compositions for carrying out the present invention, both the organization and method of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 is a diagram of an example of a server according to aspects of the of the present disclosure.

FIG. 2 is a schematic of a system for providing and publishing pricing is an

FIG. 3 is a process according to an embodiment of the present disclosure.

FIGS. 4-8 are example embodiments of user interfaces according to the present disclosure.

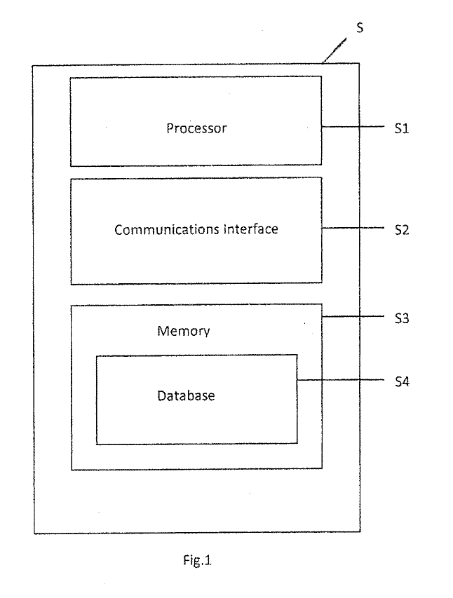

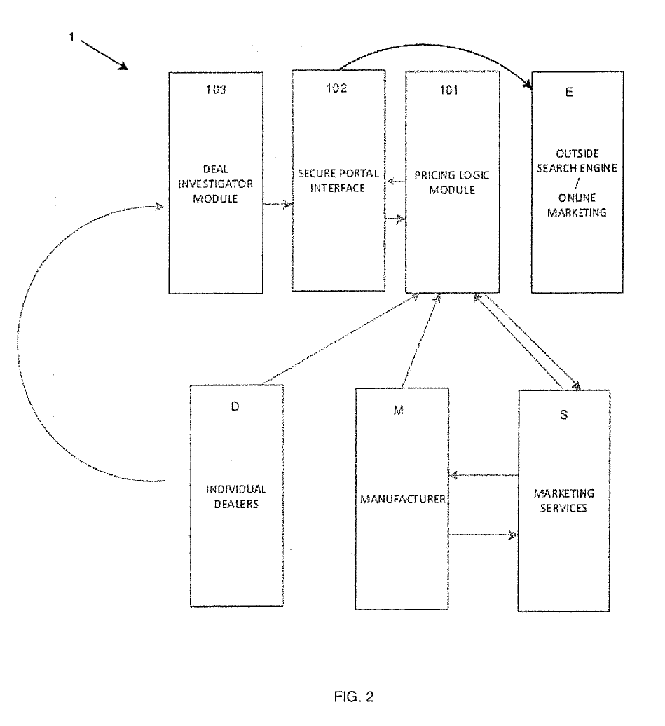

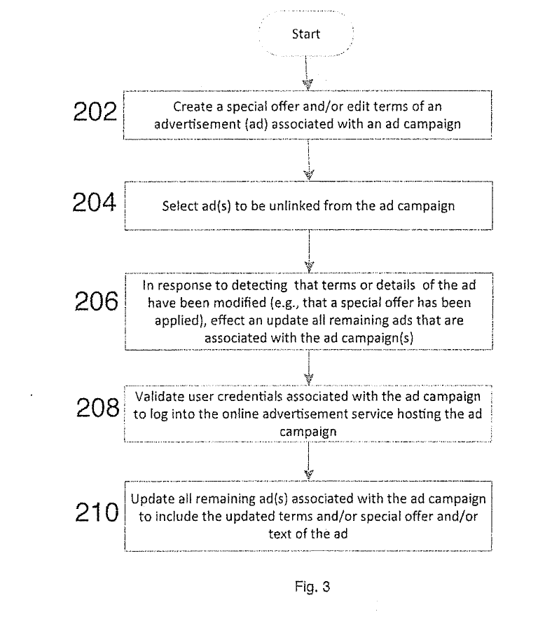

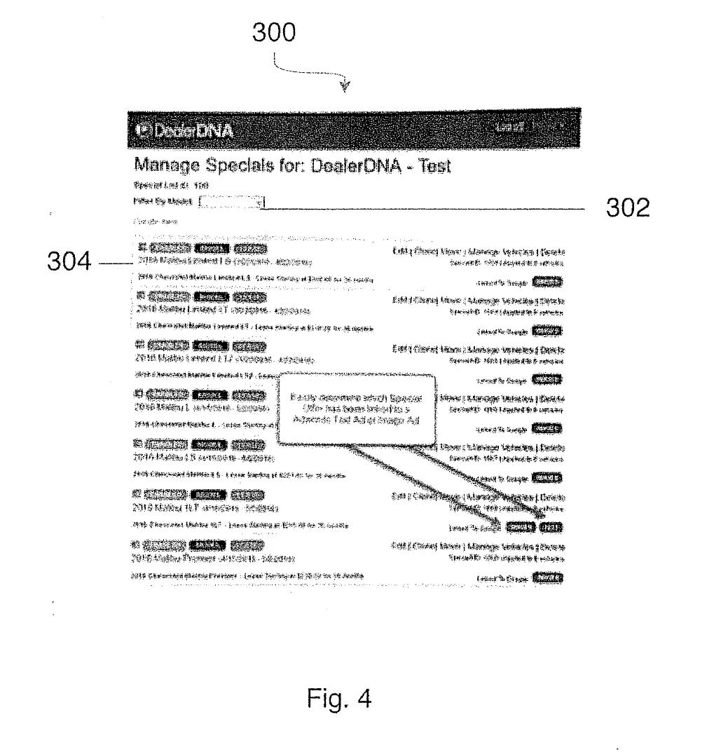

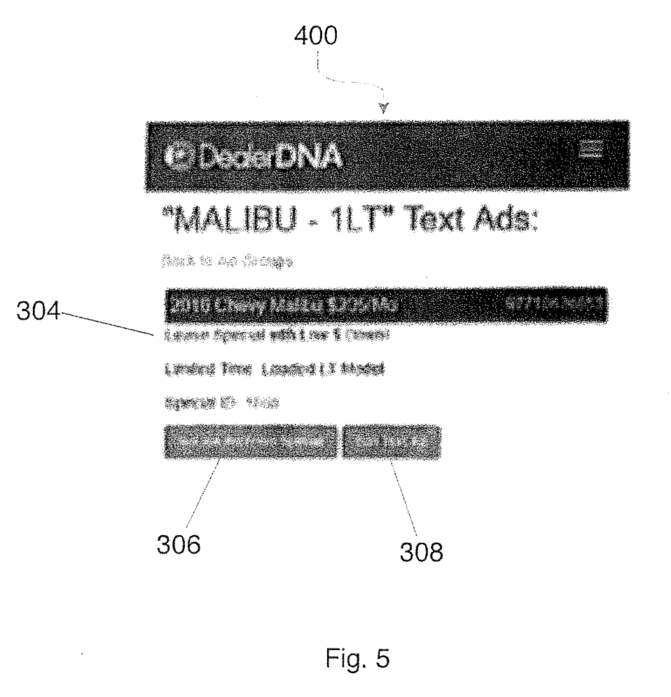

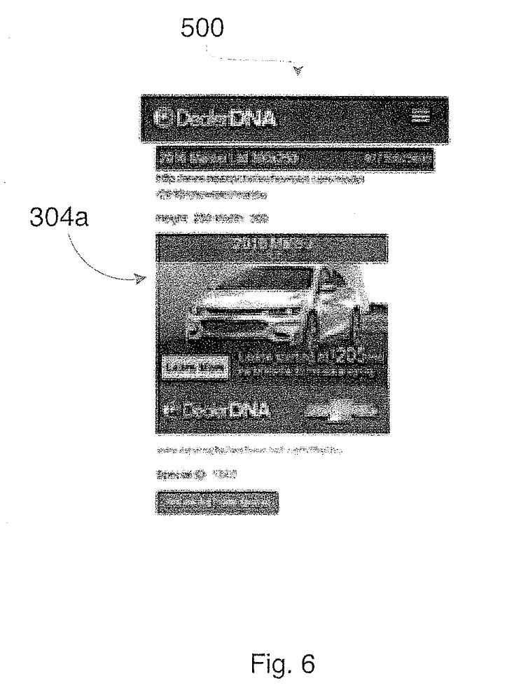

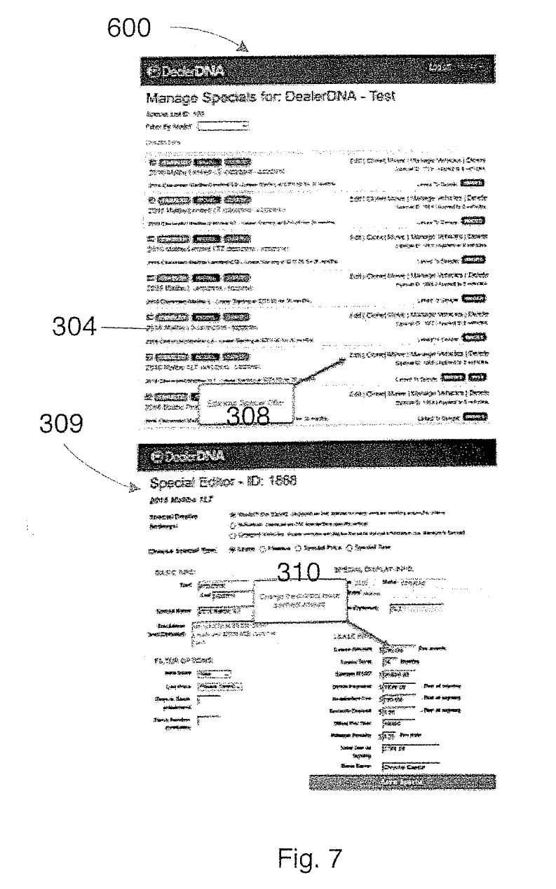

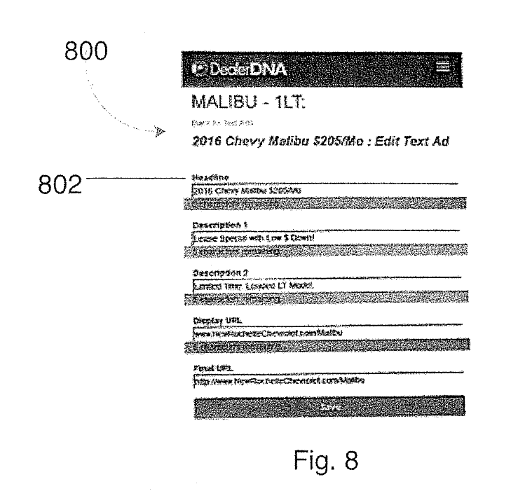

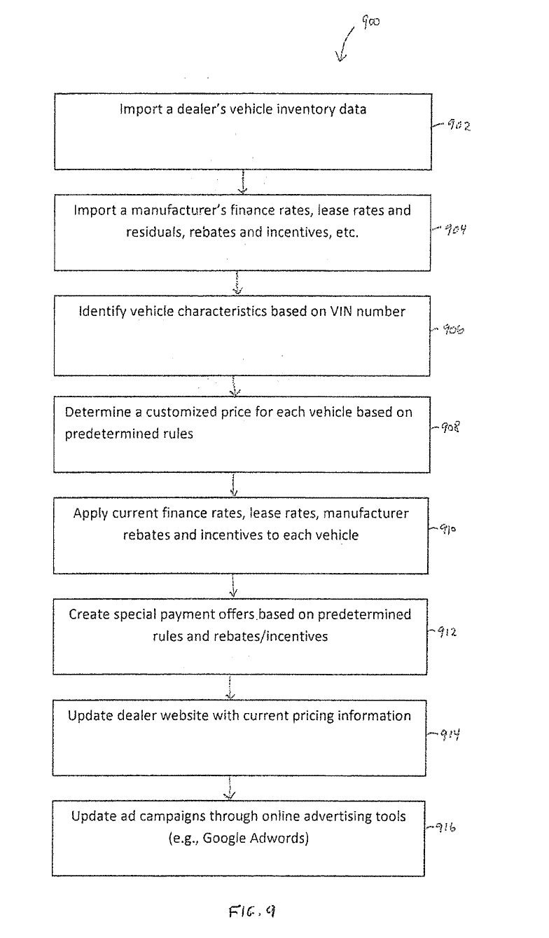

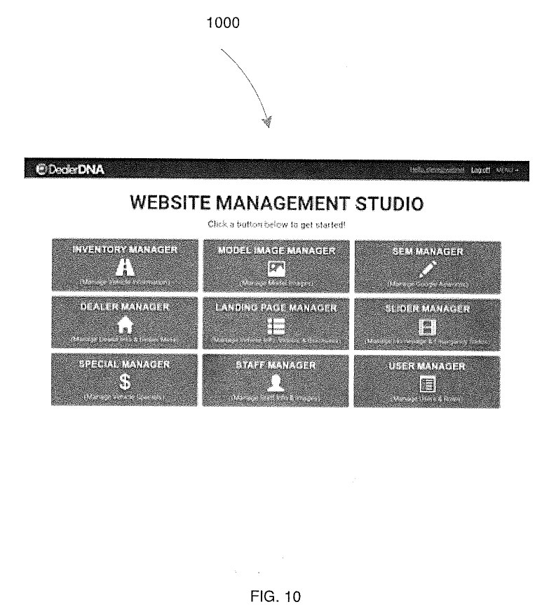

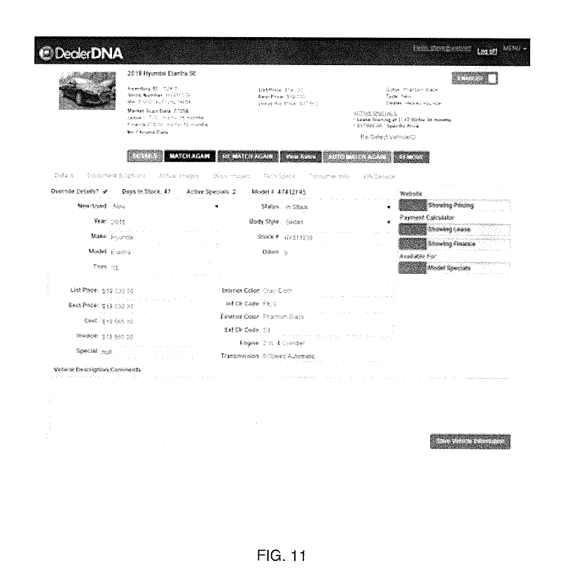

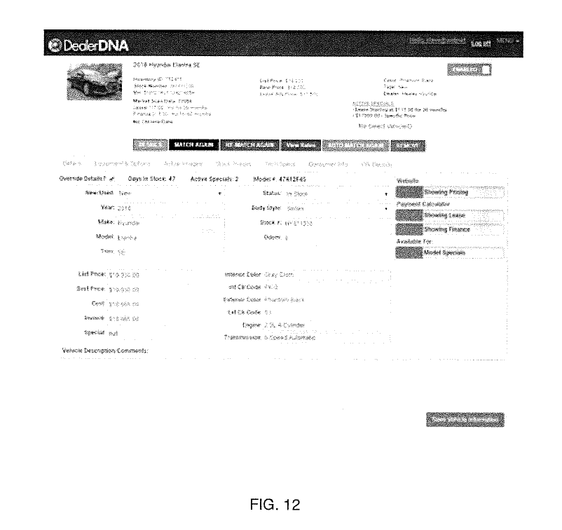

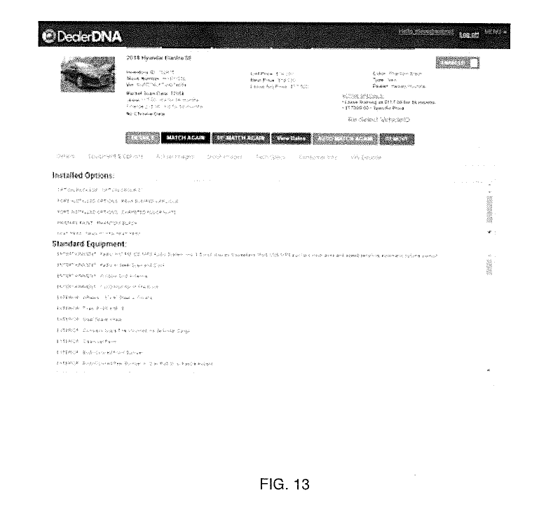

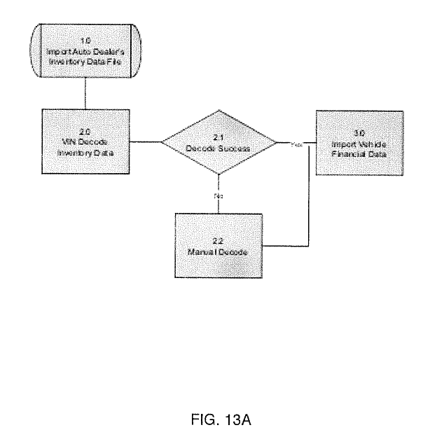

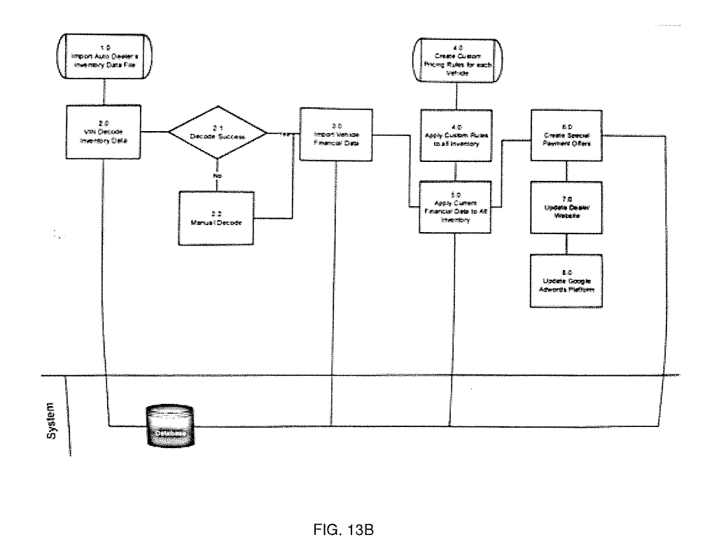

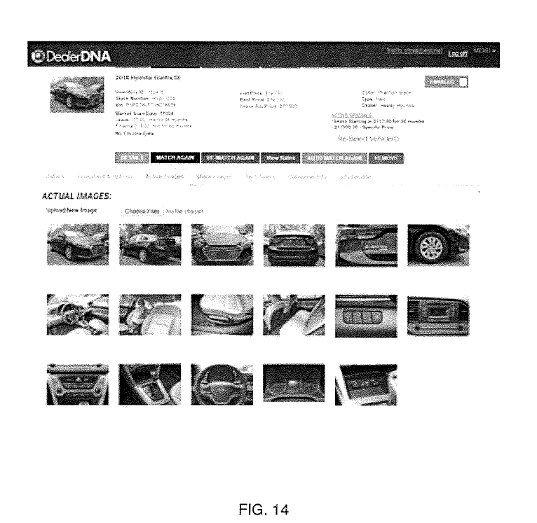

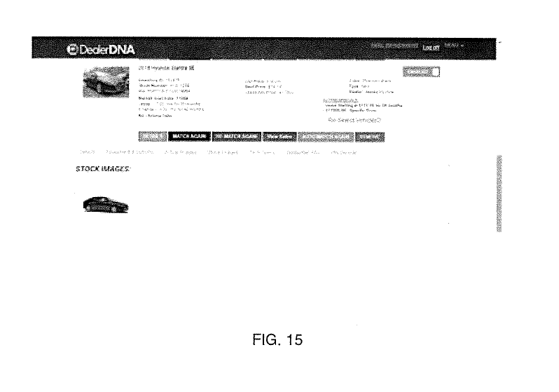

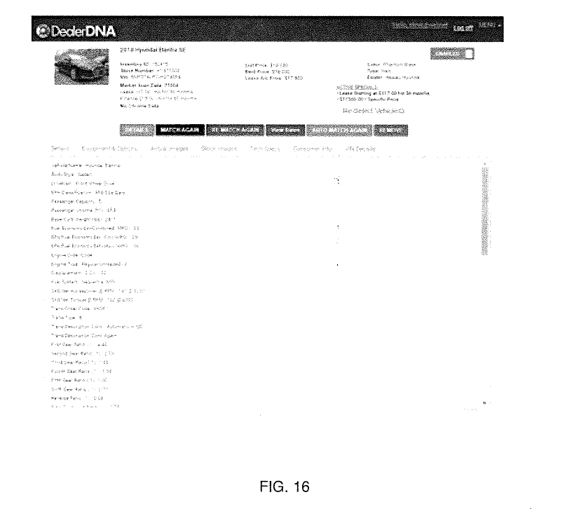

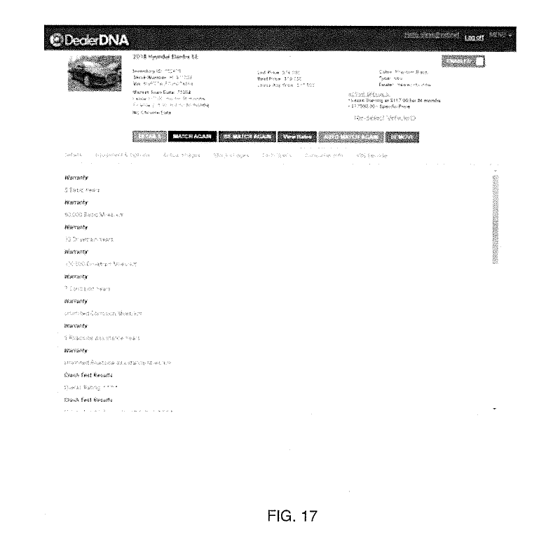

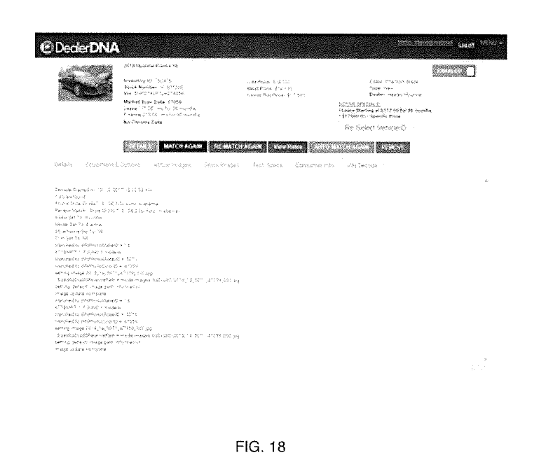

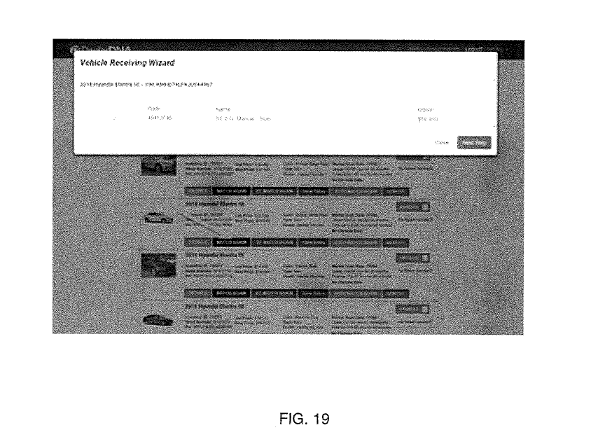

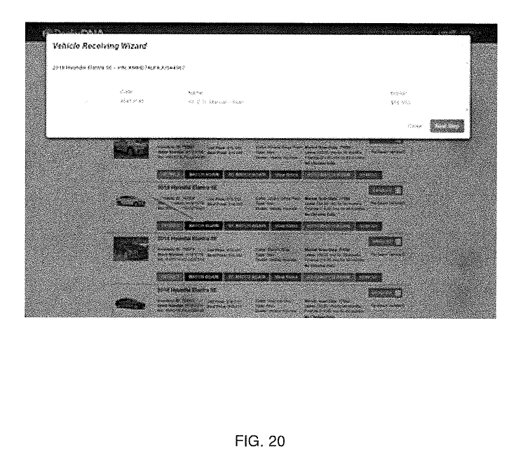

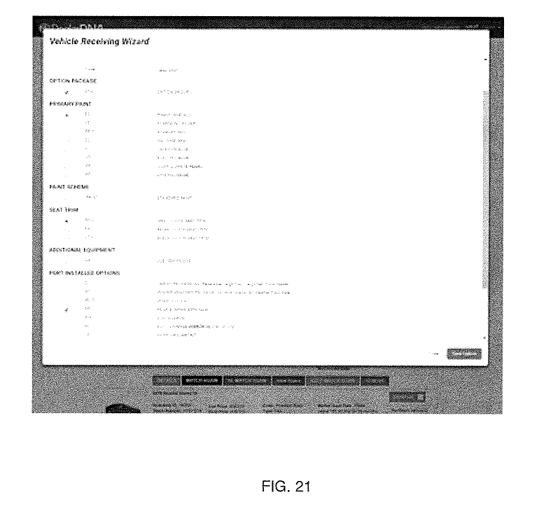

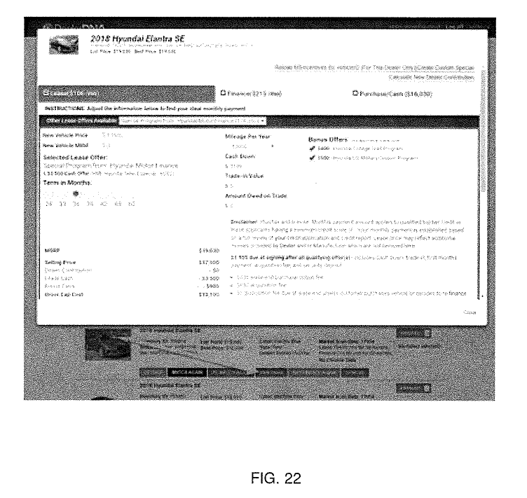

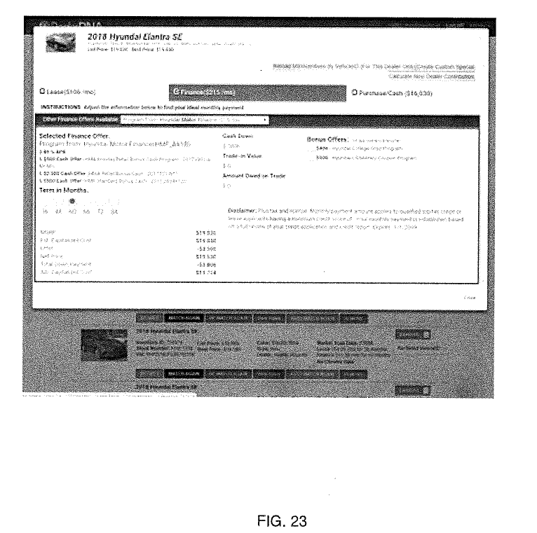

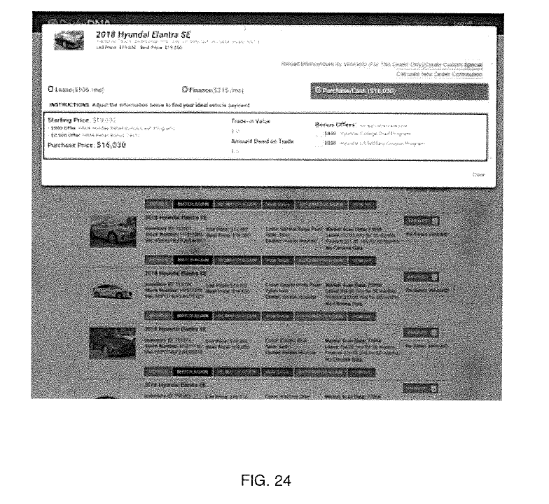

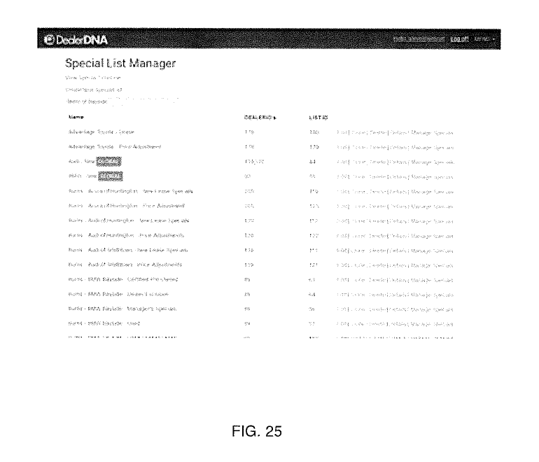

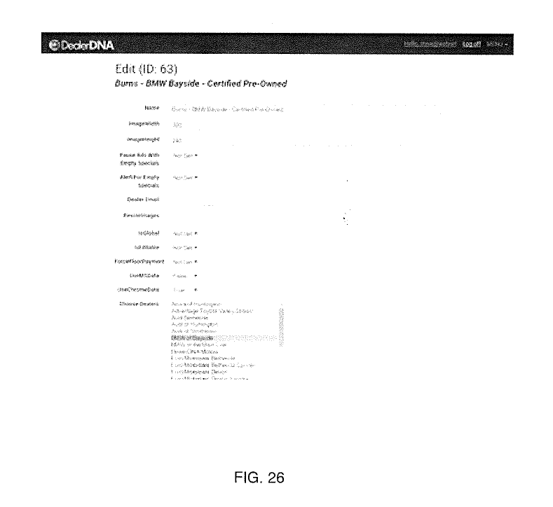

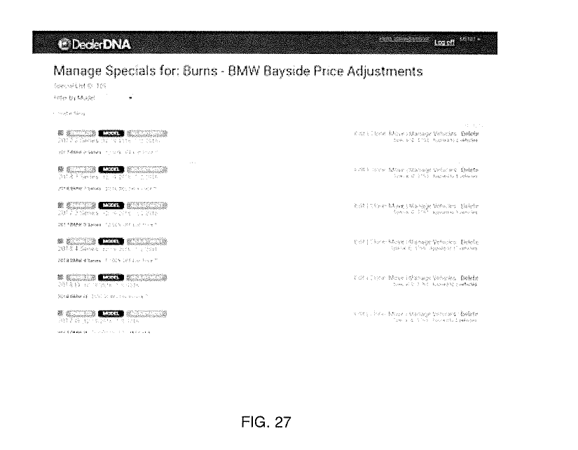

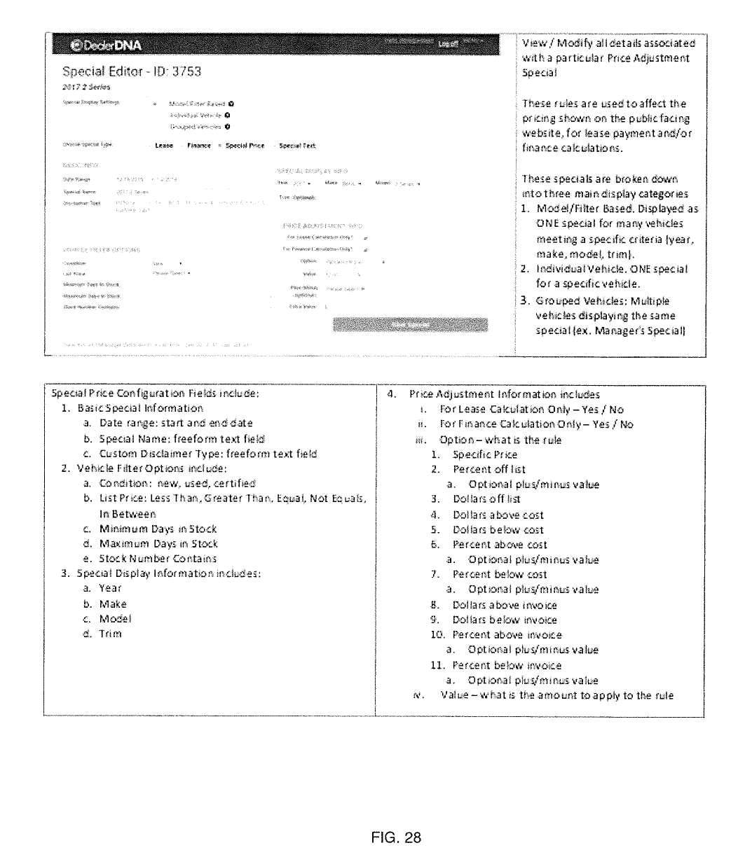

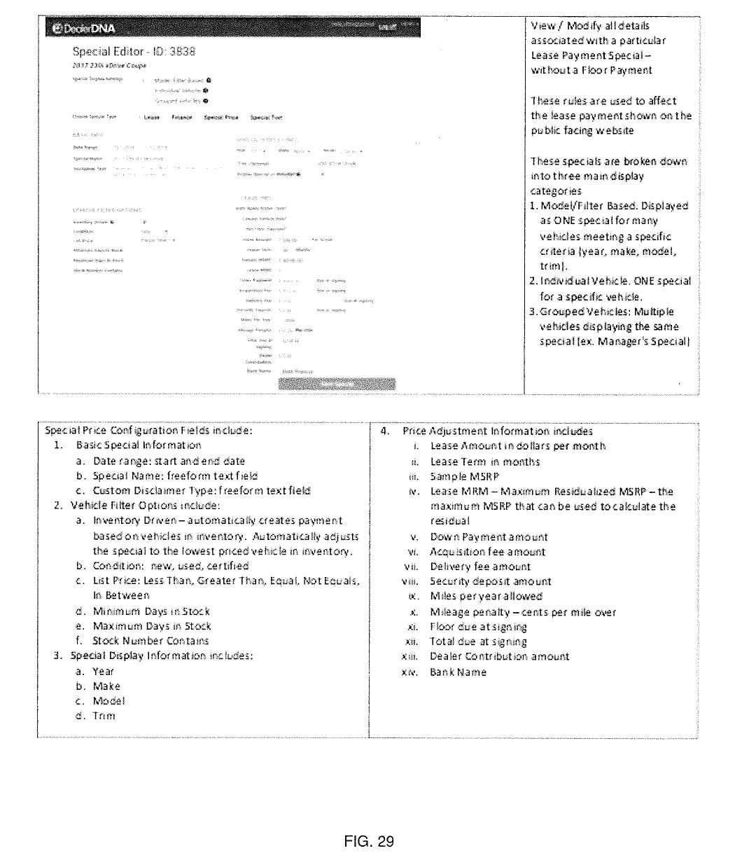

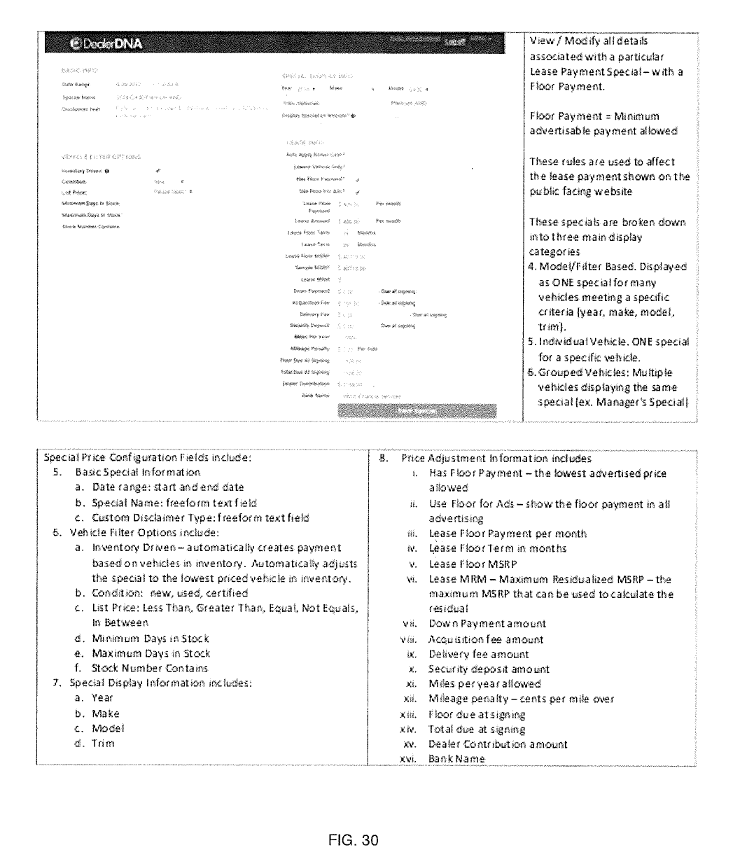

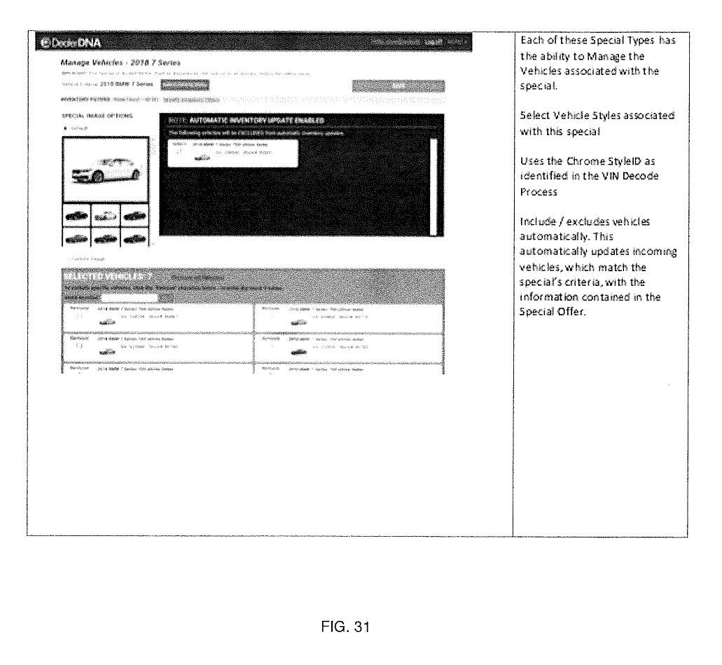

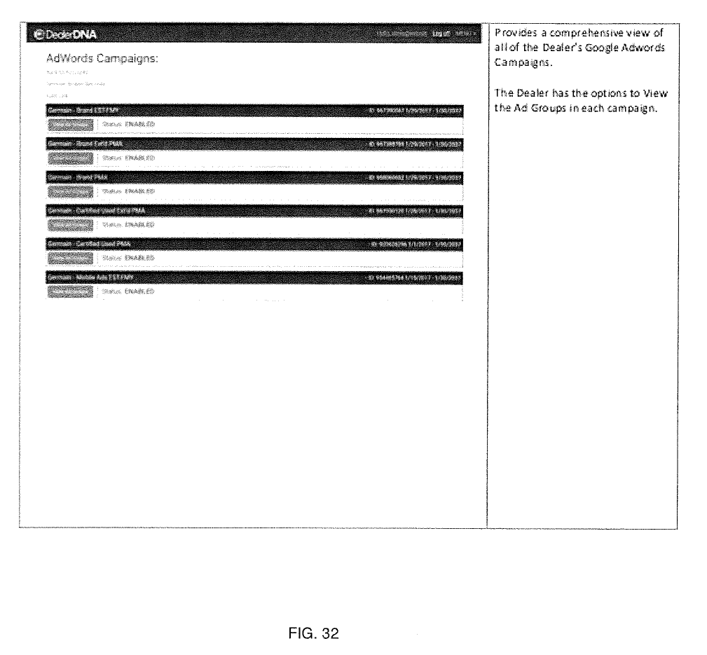

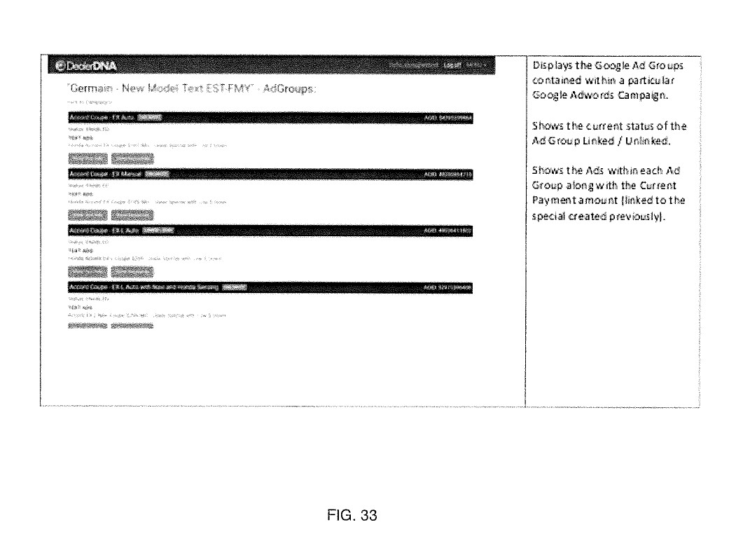

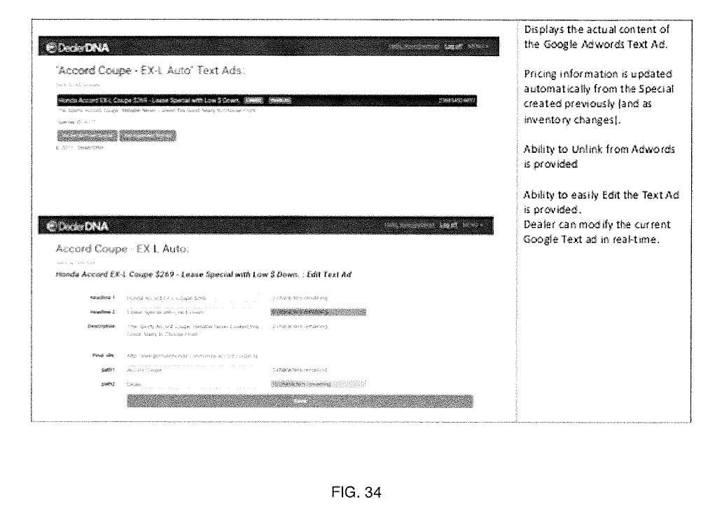

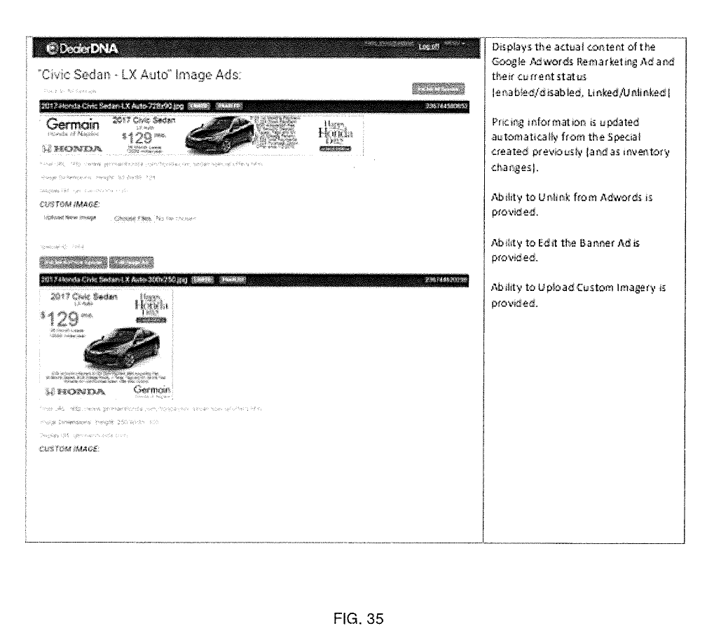

FIG. 9 is a schematic of a process according to another embodiment of the present disclosure.

FIG. 10-13 are illustrations of examples of user interfaces according to the present disclosure.

FIGS. 13A-13B are schematic illustrations of processes according to the present disclosure.

FIGS. 14-35 are illustrations of examples of user interfaces according to the present disclosure.

### DETAILED DESCRIPTION OF THE PREFERRED EMBODIMENTS

As required, a detailed illustrative embodiment of the present invention is disclosed herein. However, techniques, systems, compositions and operating structures in accordance with the present invention may be embodied in a wide variety of forms and modes, some of which may be quite different from those in the disclosed embodiment. Consequently, the specific functional details disclosed herein are merely representative, yet in that regard, they are deemed to afford the best embodiment for purposes of disclosure and to provide a basis for the claims herein which define the scope of the present invention.

Reference will now be made in detail to several embodiments of the invention that are illustrated in the accompanying drawings.

As shown in FIG. 1, a server S may include a processor S1, a communications interface S2, and/or a memory S3. According to aspects of the present disclosure, the processor S1 may include any suitable type of processing circuitry, such as a general-purpose processor (e.g., an ARM-based processor), an application-specific integrated circuit (ASIC), or a Field-Programmable Gate Array (FPGA). The communications interface S2 may include any suitable type of communications interface, such as a WiFi interface, an Ethernet interface, a Long-Term Evolution (LTE) interface, a Bluetooth Interface, an Infrared Interface, etc. The memory S3 may include any suitable type of volatile and non-volatile memory, such as random-access memory (RAM), read-only memory (ROM), a hard disk (HD), a solid state drive (SSD), a CD-ROM, flash memory, cloud storage, or network accessible storage (NAS). In some implementations, the memory S3 may store a database S4 for various information which may be updated at predetermined intervals to include such information as dealership information, inventory information, pricing information, interest rate information, etc.

A system 1 for determining pricing for various items (e.g., cars) will now be discussed with reference to FIG. 2.

The system 1 provides a pricing logic module 101 that determines pricing for use in online advertisements. The system may update a plurality of online advertisements in a synchronous fashion such that all such ads display the same pricing information at the same time.

The system 1 may include various modules for determining and updating pricing information (e.g., lease terms and financing options for each model (e.g., vehicle to be sold)). The system 1 may include a pricing logic module 101 that communicates via a secure portal interface 102 to receive information from a deal investigator module 103, which receives information from individual dealers D, and the manufacturer M. When the deal investigator module 103 receives information from individual dealers D, the information received may be sorted, converted, and prepared for use by the pricing logic module 101. Marketing services S on behalf of the manufacturer M can communicate with the pricing logic module 101 to directly input information such as financing incentives or change the price determined by the pricing logic module M for particular inventory.

When the pricing logic module 101 determines the price, it can communicate the price to the outside search engine or online marketing E including online marketing tools, such as Google AdWords and the like, via the secure portal interface 102. Text and display campaigns may be automatically updated without requiring the user to directly log in to the particular online advertising campaign tool. In particular, all of the ongoing ads may be linked in an Ad Group via the application program interface (API) which includes the pricing logic module 101 and the secure portal interface 102. New display banners are added to the associated Ad Group at the same time that the previous ad banners are disabled.

The system 1 may be configured to automatically export pricing data to the search engine tools E for the purposes of advertising. These operations may be performed in real time using definable logic strategies which may include but is not limited to lowest priced vehicle within a model/trim level and floor threshold (compliance based). The system 1 may export the lowest price inventory based on model/trim level to a website special offers page and model specific specific pages, allowing the website to “self update” without input from a web developer or dealer employee such that the dealer D always has “current offers” based on the least expensive vehicles displayed on these pages.

Further, the system 1 may automatically generate digital banner assets (e.g., graphical files) that simultaneously and exports these files in various sizes (e.g., a specific pixel dimension) to be used by the search engines E for the purpose of advertising. The banner assets may be scaled or upsized to be shown in a variety of formats, for example, for a website slide show found on a website.

As shown in FIG. 3, a process flowchart is depicted for an algorithm for synchronizing terms and/or information displayed in ad(s) for a particular ad campaign.

In particular, as shown in the FIG. 3, the process may include the following steps, which may be performed in the order as depicted or in alternative orders: At step 202, a special offer and/or terms of an advertisement associated with an ad campaign may be edited or modified. At step 204, ad(s) may be selected and unlinked from the ad campaign. At step 206, response to detecting that terms or details of the ad have been modified (e.g., that a special offer has been applied), effect an update all remaining ads that are associated with the ad campaign(s). Preferably, all ads in the ad campaign will be modified to be updated to have the same information and/or terms of the modified ad. To that end, at step 208, user credentials associated with the ad campaign to log into an online advertisement service that hosts the ad campaign may be validated. Having validated the user credentials, at step 210, the remaining linked ads may be updated to include the updated terms and/or special offers and/or modified text of the ad.

As shown in FIGS. 4-8, user interfaces for effecting such modifications of the ads associated with an ad campaign may be provided.

For example, as shown in FIG. 4, a diagram of an example user interface 300 may include a filter box 302 to effect filtering of search results by campaign or the like and a listing of search results of specials 304 for particular items, e.g., vehicles.

As shown in FIG. 5, a diagram of an example user interface 400 may include details for specials 304 for particular items, e.g., vehicles. Each of the specials 304 may include a button 306 for unlinking an ad from a particular ad campaign and/or a button 308 for editing the ad. The interface 400 is shown as a text ad, whereas the interface 500, as shown in FIG. 6, includes specials 304a that include both text and images.

Further, as illustrated in FIG. 7, a diagram of an example user interface includes a listing of specials 304, each of which may include buttons 308 for managing and/or editing terms of the specials 304. Further, as shown, the interface 600 may facilitate editing the particular terms of a special by providing editable categories 310 that correspond to particular terms of the special(s).

Further, as shown in FIG. 8, a diagram of an example user interface 800 may include a plurality of editable text categories for a special or add, including, for example, a headline, a description, a display URL, and a description URL.

A process 900 for automating ad campaigns 900 is described with reference to FIG. 9. The deal investigator module 103 and the pricing logic module 101 may be configured to perform the steps detailed in the process 900. In particular, the steps of importation of data may be performed by the deal investigator module 102 and the steps of calculating and creating prices may be performed by the pricing logic module 101.

The process 900 may include at step 902 importing an auto dealer's inventory data including all of the vehicles included in the dealer's inventory. At step 904, the process may include importing data including data related to the manufacturer for purchasing or leasing a vehicle. For example, a manufacturer may have a finance rate, lease rates and residuals, and rebates and incentives for particular vehicles. At step 906, for the vehicles identified in the auto dealer's inventory, the characteristics of the vehicles (e.g., year, model number, and the like) may be determined based on the vehicle identification number (VIN) associated with the vehicle. At step 908, a customized price for each vehicle may be determined based on predetermined rules prior to any incentives or rebates or taking into account current finance rates or lease rates. Further, at step 910, the customized price for the each vehicle may be adjusted by applying the current finance/lease rates and manufacturer rebates/incentives such that at step 912 based on the predetermined rules, as well as, the rebates and incentives offered, a special payment offer may be created. Thereafter, at step 914, the dealer websites may be updated to include current pricing information and the ads contained within an ad campaign such as those advertised via Google Adwords™, for example, may be updated. In addition, the payment information for the Google Adwords™ campaign may be updated.

At step 902, a data file from each dealer, is automatically uploaded into a secure data repository. The file type can be CSV, TXT, TSV or XML. The file's content is extracted and stored into the DDNA database. Each data source has different a file structure, thereby requiring a custom extraction process for each source. Alternatively, the extraction process may be customized. The data may be stored in customized tables in a database.

For example, at step 902:

Dealer Inventory Data Import
1. Every day, a data file from each dealer, is automatically uploaded into a secure data repository. The file type can be CSV, TXT, TSV or XML.
2. The file's content is extracted and stored into the DDNA database. Each data source has different a file structure, thereby requiring a custom extraction process for each source.
3. This data is stored in custom tables inside the Database

At step 904, the vehicle characteristics are determined. In particular, This process entails using the Vehicle Identification Number (VIN) to determine the vehicle's Year, Make, Model and Trim. This process uses a private web-based API service provided by Chrome Data, Inc. Further, the VIN once decoded may show the manufacturer build data for the vehicle. In other cases, additional information may be provided to “assist” the decode process. This data may typically is provided in the data file provided by the dealer and may include installed options, model number and exterior/interior color codes. In particular, custom logic may be included to extract and send data into a web-service, e.g., Chrome™ website which may provide additional vehicle information for an associated VIN number. Once decoded, a vehicle Style ID may be assigned to each vehicle such that within the Chrome™ API service, manufacturer finance rates, lease rates and residuals and rebates and incentives can be automatically determined. In the event that such details cannot be automatically matched to a particular vehicle style ID, such information may be manually entered.

Further, there may also be a step of decoding each of the vehicles using a VIN decode engine which may also include accessing external databases including data associated with a particular VIN number. At this step:
1. This process entails using the Vehicle Identification Number (VIN) to determine the vehicle's Year, Make, Model and Trim. This process uses a private web-based API service provided by Chrome Data, Inc.
   (1) In certain cases, the VIN decode will show the manufacturer build data for the vehicle.
   (2) In other cases, our tool supplies additional information to “assist” the decode process. This data may typically is provided in the data file provided by the dealer and may include installed options, model number and exterior/interior color codes.
      1. This is achieved by using custom logic which we have developed to extract and send this data into the Chrome web-service
2. The end result of this process is the assignment of a Chrome StyleID to each vehicle. The enables the system to automatically determine the proper Manufacturer Finance Rates, Lease Rates and Residuals, Rebates and Incentives rebate/incentives (as identified in Step 3).
3. In the event that a vehicle can not be automatically matched to a particular Chrome StyleID, we have built a software interface to allow dealers to manually select the correct StyleID.

At steps 902-906, a web based API call may be made in which information is supplied regarding a vehicle (e.g., model, trim, year) and vehicle status (e.g., new or used). Further, information regarding special programs may be provided such as (a) program name; (b) program effective and expiration date; (c) program type, which may include (i) subvented retail finance; (ii) subvented lease; (iii) non-subvented retail finance; and (iv) cash purchase; (d) program value; (e) program rules; (f) incentive name and incentive ID number; (g) incentive value; (h) incentive effective and expiration date; and (i) stackability ID. The information that would include current finance rates and terms; current lease rate money factors and residual value percentage; current customer rebates and incentives; and current dealer rebates and incentives.

At step 908, a customized price may be determined based on a predetermined set of rules. In particular, the dealer has the ability to create custom pricing rules for every vehicle in the inventory. These rules are used to affect the pricing shown on the public facing website, for lease payment calculations and or finance calculations. These rules are broken down into three main display categories: i. Model/Filter Based. Displayed as ONE special for many vehicles meeting a specific criteria (year, make, model, trim); ii. Individual Vehicle. ONE special for a specific vehicle; and iii. Grouped Vehicles: Multiple vehicles displaying the same special, which may be for example, a manager's special. Inside of each category is a distinct special price configurator. In particular, basic information about the special would be included. Such information may include a date range including start and end date, a special name, which may be entered via a freeform text field. Also included may be a custom disclaimer type, which may be entered via a freeform text field. The vehicle filter options may include: (a) Condition: new, used, certified; and (b) List Price: (i) Less Than, (ii) Greater Than, (iii) Equal, (iv) Not Equals, and/or (v) In Between a range of prices. In addition, the inventory data may be filtered according to the minimum days in stock and the maximum days in stock that an item is in stock. Further, the data may be filtered according to a particular stock number. Special display information may also include: a. Year; b. Make; c. Model; and d. Trim.

At step 908: Apply custom pricing rules for each vehicle, as specified by the Dealer
1. The DealerDNA platform provides the dealer with the ability to create custom pricing rules for every vehicle in their inventory.
2. These rules are used to affect the pricing shown on the public facing website, for lease payment calculations and or finance calculations.
3. These rules are broken down into three main display categories
   (1) Model/Filter Based. Displayed as ONE special for many vehicles meeting a specific criteria (year, make, model, trim).
   (2) Individual Vehicle. ONE special for a specific vehicle.
   (3) Grouped Vehicles: Multiple vehicles displaying the same special (ex. Manager's Special)
4. Inside of each category is a distinct Special Price configurator
   (1) Special Price
      1. Includes basic information about the special
         a. Date range: start and end date
         b. Special Name: freeform text field
         c. Custom Disclaimer Type: freeform text field
      2. Vehicle Filter Options include:
         a. Condition: new, used, certified
         b. List Price: Less Than, Greater Than, Equal, Not Equals, In Between
         c. Minimum Days in Stock
         d. Maximum Days in Stock
         e. Stock Number Contains
      3. Special Display Information includes:
         a. Year
         b. Make
         c. Model
         d. Trim
      4. Price Adjustment Information includes
         a. For Lease Calculation Only—Yes/No
         b. For Finance Calculation Only—Yes/No
         c. Option—what is the rule
         i. Specific Price
         ii. Percent off list
         1. Optional plus/minus value
         iii. Dollars off list
         iv. Dollars above cost
         v. Dollars below cost
         vi. Percent above cost
         1. Optional plus/minus value
         vii. Percent below cost
         1. Optional plus/minus value
         viii. Dollars above invoice
         ix. Dollars below invoice
         x. Percent above invoice
         1. Optional plus/minus value
         xi. Percent below invoice
         1. Optional plus/minus value
         d. Value—what is the amount to apply to the rule
5. Each of these Special Types has the ability to select the vehicles associated with the special.
   (1) Select Vehicle Styles associated with this special
      1. Uses the Chrome StyleID as identified in the VIN Decode Process
   (2) Include/excludes vehicles automatically
   (3) This automatically updates incoming vehicles, which match the special's criteria, with the information contained in the Special Offer.

At step 910, the current finance rates, leases rates, rebates and incentives may be applied to the customized price such that a special price is adjusted and determined. At predetermined time intervals, the system may use custom programming logic to apply the current rates, rebates and incentives to every vehicle. This information may be appended to a Vehicle object in the database. This information is required to create the Special Payment Offers at step 912. Each Rate, Rebate and Incentive is processed via our custom algorithm to check for compatibility and stackability with all of the rates, rebates and incentives provided for the particular vehicle. With this information, we calculate the best payment available—using the funding source provided and the maximum rebate available for Financing, leasing and/or Purchasing the vehicle. Further, the payment information may be stored on the Vehicle Object on the database and displayed in a payment calculator widget. The prices may be individualized for vehicles or may be applied to a group of vehicles having certain characteristics.

At step 910: Manufacturer Finance Rates, Lease Rates and Residuals, Rebates and Incentives Import
a. Every day, our system uses custom programming logic to make web-based API calls to Chrome Data's Incentive Service for every vehicle.
b. The information supplied in these API calls include:
   i. Vehicle—year make model trim—based on Chrome StyleID
   ii. Vehicle Status—New or Used
c. The information returned from the Chrome Incentive API service includes:
   i. Program Name
   ii. Program Effective and Expiration dates
   iii. Program Type
      1. Subvented Retail Finance
      2. Subvented Lease
      3. Non-Subvented Retail Finance
      4. Non-Subvented Lease
      5. Cash Purchase
   iv. Program Value
   v. Program Rules
   vi. Incentive Name and Incentive ID number
   vii. Incentive Value
   viii. Incentive Effective and Expiration dates
   ix. Stackability ID
d. The Information utilized in this import process includes:
   i. Current finance rates and terms
   ii. Current lease rate money factors and residual value percentage.
   iii. Current Customer Rebates and Incentives
   iv. Current Dealer Rebates and Incentives

Further, at step 910:

Apply all current Manufacturer Finance Rates, Lease Rates, Rebates and Incentives to each vehicle.
1. Every day, our system uses custom programming logic to apply the current rates, rebates and incentives to every vehicle.
   (1) This information is appended to the Vehicle object in the DealerDNA database.
   (2) This information is required to create the Special Payment Offers in Step 6
   (3) Each Rate, Rebate and Incentive is processed via our custom algorithm to check for compatibility and stackability with all of the rates, rebates and incentives provided for the particular vehicle.
      1. With this information, we calculate the best payment available—using the funding source provided and the maximum rebate available
         a. For both Finance, Lease and Purchase
      2. This payment information is stored on the Vehicle Object on the DealerDNA database and displayed in the DealerDNA Payment Calculator widget.

Further, the information provided in the database will be based on whether the price is to be determined for a lease or a financing option.

For a lease, the following basic information about the special may be included: Date range: start and end date; Special Name: freeform text field; and Custom Disclaimer Type: freeform text field. As discussed, he vehicle filter options may include: Inventory Driven—automatically creates payment based on vehicles in inventory. Automatically adjusts the special to the lowest priced vehicle in inventory; Condition: new, used, certified; List Price: Less Than, Greater Than, Equal, Not Equals, In Between; Minimum Days in Stock; Maximum Days in Stock; and Stock Number Contains. Further, the Special Display Information may include: Year; Make; Model; and Trim.

The lease information may include information may include the following versions:
a. Floor Payment Version
   i. Has Floor Payment—the lowest advertised price allowed
   ii. Use Floor for Ads—show the floor payment in all advertising
   iii. Lease Floor Payment per month
   iv. Lease Floor Term in months
   v. Lease Floor MSRP
   vi. Lease MRM—Maximum Residualized MSRP—the maximum MSRP that can be used to calculate the residual
   vii. Down Payment amount
   viii. Acquisition fee amount
   ix. Delivery fee amount
   x. Security deposit amount
   xi. Miles per year allowed
   xii. Mileage penalty—cents per mile over
   xiii. Floor due at signing
   xiv. Total due at signing
   xv. Dealer Contribution amount
   xvi. Bank Name
b. Non-Floor Payment Version
   i. Has Floor Payment—the lowest advertised price allowed
   ii. Use Floor for Ads—show the floor payment in all advertising
   iii. Lease Floor Payment per month
   iv. Lease Floor Term in months
   v. Lease Floor MSRP
   vi. Lease MRM—Maximum Residualized MSRP—the maximum MSRP that can be used to calculate the residual
   vii. Down Payment amount
   viii. Acquisition fee amount
   ix. Delivery fee amount
   x. Security deposit amount
   xi. Miles per year allowed
   xii. Mileage penalty—cents per mile over
   xiii. Floor due at signing
   xiv. Total due at signing
   xv. Dealer Contribution amount
   xvi. Bank Name

In the Finance version, the following information may be included: Date range: start and end date; Special Name: freeform text field; and Custom Disclaimer Type, which may be provided via a freeform text field. The filter options may include: Condition: new, used, certified; List Price: Less Than, Greater Than, Equal, Not Equals, In Between; Minimum Days in Stock; Maximum Days in Stock; and Stock Number Contains. The special display information may include: Year; Make; Model; Trim; Display special on website—Yes/No; Finance Information includes; APR Value in percent format; Finance Term in Months; and Minimum Down payment amount; and/or amount due at signing.

The vehicles associated with the specials may be managed by selecting vehicle styles to be associated with the special and/or using particular VIN numbers for select vehicles such that vehicles may be included or excluded from particular specials.

At step 912, certain rules may be applied for creating a special price. In particular, the information for determining a price adjustment may include several queries and options, including, for example: a. For Lease Calculation Only—Yes/No; b. For Finance Calculation Only—Yes/No; c. Option rules may also be applied: For example, there may be a percent off or a plus/minus value or percentage that is applied to the price. Also, for example, the price above or below as a percentage or value of an invoice price of the vehicle may be set such that the price does not exceed or fall below certain threshold values or is set at a specified value.

At step 912: Create Special Payment Offers—based on custom rules and rebates/incentives
1. The platform may provide the dealer with the ability to create custom payment (Lease or Finance) rules for every vehicle in their inventory.
2. These rules are used to affect the Lease or Finance payments shown on the public facing website.
3. These Specials are broken down into three main display categories
   (1) Model/Filter Based. Displayed as ONE special for many vehicles meeting a specific criteria (year, make, model, trim).
   (2) Individual Vehicle. ONE special for a specific vehicle.
   (3) Grouped Vehicles: Multiple vehicles displaying the same special (ex. Manager's Special)
4. Inside of each category is two distinct Special Types
   (1) Lease
      1. Includes basic information about the special
         a. Date range: start and end date
         b. Special Name: freeform text field
         c. Custom Disclaimer Type: freeform text field
      2. Vehicle Filter Options include:
         a. Inventory Driven—automatically creates payment based on vehicles in inventory. Automatically adjusts the special to the lowest priced vehicle in inventory.
         b. Condition: new, used, certified
         c. List Price: Less Than, Greater Than, Equal, Not Equals, In Between
         d. Minimum Days in Stock
         e. Maximum Days in Stock
         f. Stock Number Contains
      3. Special Display Information includes:
         a. Year
         b. Make
         c. Model
         d. Trim
      4. Lease Information includes:
         a. Floor Payment Version (Floor Payment=minimum advertisable payment allowed)
         i. Has Floor Payment—the lowest advertised price allowed
         ii. Use Floor for Ads—show the floor payment in all advertising
         iii. Lease Floor Payment per month
         iv. Lease Floor Term in months
         v. Lease Floor MSRP
         vi. Lease MRM—Maximum Residualized MSRP—the maximum MSRP that can be used to calculate the residual
         vii. Down Payment amount
         viii. Acquisition fee amount
         ix. Delivery fee amount
         x. Security deposit amount
         xi. Miles per year allowed
         xii. Mileage penalty—cents per mile over
         xiii. Floor due at signing
         xiv. Total due at signing
         xv. Dealer Contribution amount
         xvi. Bank Name
         b. Non-Floor Payment Version
         i. Lease Amount in dollars per month
         ii. Lease Term in months
         iii. Sample MSRP
         iv. Lease MRM—Maximum Residualized MSRP—the maximum MSRP that can be used to calculate the residual
         v. Down Payment amount
         vi. Acquisition fee amount
         vii. Delivery fee amount
         viii. Security deposit amount
         ix. Miles per year allowed
         x. Mileage penalty—cents per mile over
         xi. Floor due at signing
         xii. Total due at signing
         xiii. Dealer Contribution amount
         xiv. Bank Name
   (2) Finance
      1. Includes basic information about the special
         a. Date range: start and end date
         b. Special Name: freeform text field
         c. Custom Disclaimer Type: freeform text field
      2. Vehicle Filter Options include:
         a. Condition: new, used, certified
         b. List Price: Less Than, Greater Than, Equal, Not Equals, In Between
         c. Minimum Days in Stock
         d. Maximum Days in Stock
         e. Stock Number Contains
      3. Special Display Information includes:
         a. Year
         b. Make
         c. Model
         d. Trim
         e. Display special on website—Yes/No
      4. Finance Information includes
         a. APR Value in percent format
         b. Finance Term in Months
         c. Minimum Down payment amount
         i. Due at signing (optional)
5. Each of these Special Types has the ability to Manage the Vehicles associated with the special.
   (1) Select Vehicle Styles associated with this special
      1. Uses the Chrome StyleID as identified in the VIN Decode Process
   (2) Include/excludes vehicles automatically
6. This automatically updates incoming vehicles, which match the special's criteria, with the information contained in the Special Offer.

At step 914, the dealer website is updated with current pricing information. Once the update procedures (VIN Decodes, Rates/Incentives, Special Pricing, and Special Offers) have completed, this information is programmatically fed to the Dealer's website. On the various Landing Pages within a Dealer's website, we programmatically display the lowest payment priced vehicle. If this lowest priced vehicle is sold, we automatically display the next lowest priced vehicle from the Dealer's inventory. At step 914 in the process the system provides an automatic updating of the Google Text Ads and Remarketing Banners. This process uses a custom algorithms and the Google Adwords API web service to properly update the appropriate ads/banners. The Custom programming follows this process: 1. Validate our credentials; 2. Retrieve existing Adwords Campaign information; 3., Retrieve existing Text and Image ads; 4. Update Text ads: (a) change payment information; and (b) enable/disable ads based on inventory availability; and 5. Update Banner Image ads: (a) change payment information; and (b) enable/disable ads based on inventory availability.

At step 914: Update Dealer Website with current pricing info
e. Once the update procedures (VIN Decodes, Rates/Incentives, Special Pricing, and Special Offers) have completed, this information is programmatically fed to the Dealer's website.
f. On the various Landing Pages within a Dealer's website, we programmatically display the lowest payment priced vehicle.
   i. If this lowest priced vehicle is sold, we automatically display the next lowest priced vehicle from the Dealer's inventory.

At step 916: Update Google Adwords campaigns with updated payment info
1. The last step in the process is the automatic updating of the Google Text Ads and Remarketing Banners
2. This process uses a custom algorithms and the Google Adwords API web service to properly update the appropriate Google Text Ads and Remarketing Banners
   (1) The Custom programming follows this process
      1. Validate our credentials
      2. Retrieve existing Adwords Campaign information
      3. Retrieve existing Text and Image ads
      4. Update Text ads
         a. change payment information
         b. enable/disable ads based on inventory availability
      5. Update Banner Image ads
         a. change payment information
         b. enable/disable ads based on inventory availability

Customize information and filtering may also be provided as follows:

Special Text
1. Includes basic information about the special
   (1) Date range: start and end date
   (2) Special Name: freeform text field
   (3) Custom Disclaimer Type: freeform text field
2. Vehicle Filter Options include:
   (1) Condition: new, used, certified
   (2) List Price: Less Than, Greater Than, Equal, Not Equals, In Between
   (3) Minimum Days in Stock
   (4) Maximum Days in Stock
   (5) Stock Number Contains
3. Special Display Information includes:
   (1) Display Text—what is the Special text to display on each vehicle
   (2) Year
   (3) Make
   (4) Model
   (5) Trim

FIG. 10 is an example of a user interface 1000 in accordance with the present disclosure including an inventory manager, a dealer manager, a special manager, a model image manager, a landing page manager, a staff manager, a sem manager, a slider manager, and a user manager. The inventory manager enables management of vehicle information, the dealer manager enables management of dealer info and dealer meta, the special manager enables management of vehicle specials, the model image manager enables management of model images, the landing page manager enables management of vehicle info, videos, and brochures, the staff manager enables management of staff info and images, the SEM manager enables management of Google Adwords™, the slider manager enables management of homepage and emergency slides, the user manager enables management of users and roles.

The three main components of the portal used in the platform are the Inventory Manager, Specials Manager and SEM Manager. There are other components which are vital to the proper functioning of the system; such as Model Image Manager and Landing Page Manager. The Inventory Manager module provides the Dealer with the ability to easily view and modify the information related to every vehicle. This information includes critical consumer-related information to the dealer, such as, VIN, MSRP, Selling Price, Special Price, Days in Stock, Interior and Exterior Color, Installed Equipment and Options, Standard Equipment, Warranty, Safety, Fuel Economy Information, Current Incentives and Rebates, Lease and Finance calculations.

The Specials Manager module provides the Dealer with the ability to create custom pricing rules and special offers for every vehicle in their inventory. The rules created in this module are critical to the overall function of the platform. These rules affect the customer-facing purchase pricing along with the Lease and Finance Payment calculations. The Model Image Manager module is an internally-used tool which provides management of the color correct imagery for the Dealer's inventory. This repository contains thousands of images which have been created. These images are specific for every new vehicle by Year, Make, Model and Trim. Each specific trim can contain different images than a similar model/trim in the same brand. For instance, a Honda Pilot LX could have different colors and wheel combinations than a Honda Pilot EX. This imagery is used during the Special Offers creation process to make sure the ads are compliant with the Manufacturer's Guidelines. Failure to be compliant can result in financial penalties for the Dealer. Without this imagery, the Special Offer would not be able to be displayed. The SEM Manager module provides the Dealer with the “linking” technology to tie each special to the Dealer's Google Adwords™ Search Marketing campaigns. This linkage is vitals-to assure that the information displayed in the Google Search Engine matches the information being displayed on the Dealer's website. The Landing Page Manager module is an internally-used tool which provides management of the content used in the platform to display marketing information to the Dealer's website visitor. These pages are specific to every Year, Make and Model of a Manufacturer's vehicle product line. This information is displayed in the Dealer's website on custom Landing Pages as part of the Marketing Platform. All Google Search Engine related activities redirect the Web-searcher to these Landing Pages. This advanced linking is critical to the success of the Dealer's digital marketing strategy. The Inventory Manager module provides the Dealer with the ability to easily view and modify the information related to every vehicle. This information includes critical consumer-related information to the dealer, such as, VIN, MSRP, Selling Price, Special Price, Days in Stock, Interior and Exterior Color, Installed Equipment and Options, Standard Equipment, Warranty, Safety, Fuel Economy Information, Current Incentives and Rebates, Lease and Finance calculations.

Further, the Specials Manager module provides the Dealer with the ability to create custom pricing rules and special offers for every vehicle in their inventory. The rules created in this module are critical to the overall function of the Synergie Platform. These rules affect the customer-facing purchase pricing along with the Lease and Finance Payment calculations.

The flexibility of this system allows the Dealer to create a vast number of “price-adjustment” specials to suit their particular style of conducting business. Dealers can create discounts based on percentage above or below List Price, Cost or Invoice. Also, Dealers can create discounts based dollar amounts above or below List Price, Cost or Invoice. These pricing rules can affect how the Lease and Finance payments are calculated. They also affect what is displayed to the consumer on the Dealers website.

In addition, Dealers can create custom Lease and Finance Special Offers. Each of these can be as generic or specific as needed. For instance, Finance Special Offer may provide an APR rate for an entire model line, such as a Chevrolet Cruze. While a Lease Special Offer could require a higher down payment for a Chevrolet Cruze LT model than the Chevrolet Cruze LS. These types of variations are usually related to the current marketing strategy of the Dealer and/or Manufacturer (typically based on inventory availability).

As shown in FIG. 11 is an example user interface for providing vehicle information including details, equipment and options, actual, images, stock images, technical specifications, consumer information, and/or VIN decode details.

As shown in FIG. 12, an example user interface for providing complete vehicle information including: Year, Make, Model, Trim, New/Used, Stock Status, Body Style, Stock Number, Odometer, Pricing (e.g., List, Best, Cost, Invoice, Special), Interior & Exterior Colors, Engine, Transmission, Days in stock, Manufacturer Model #, # of Active Specials, and/or Vehicle Comments. Dealer is able to Override all details related to each vehicle. For each vehicle on a Dealer's website, they are able to show/hide: Pricing; Lease Calculator; Finance Calculator; and/or Model Specials. This information may be extracted during our VIN Decode process which uses multiple sources including Chrome Data and the Dealer's Dealership Management System.

As shown in FIG. 13, an example user interface for providing equipment option information including: Installed Equipment; and Standard Equipment (e.g., Entertainment, Exterior, Interior, Safety, and/or Mechanical). This information is extracted during our VIN Decode process which uses multiple sources including Chrome Data and the Dealer's Dealership Management System.

For example, as shown in FIGS. 13A-B, processes including steps for importing data, decoding the data based on VIN data and Chrome or other third party data associated with the VIN data, applying rules to determine special offers are shown.

As shown in FIG. 14, an example user interface for providing vehicle image details which may be customized to include dealer provided photography such as uploading a single image, uploading bulk images, and/or reordering image display for dealer website. Any uploaded image is automatically resized to the proper dimensions based on the dealer's website.

As shown in FIG. 15, an example user interface for providing vehicle image details for inventory stock including showing the color correct image for each vehicle. The list is managed via the Model Image Manager component of the portal.

As shown in FIG. 16, an example user interface for providing technical information about each vehicle including: EPA Estimates; Engine performance; Transmission details; Vehicle Dimensions; Cargo Capacity; Seating; and/or Vehicle Weight.

As shown in FIG. 17, an example user interface for providing consumer information about each vehicle including: Warranty; and/or Crash Test Results.

As shown in FIG. 18, an example user interface for providing VIN Decode information about each vehicle. This information is extracted during our VIN Decode process which uses multiple sources including Chrome Data and the Dealer's Dealership Management System. This page is primarily used as a troubleshooting mechanism.

As shown in FIG. 19 is an example user interface for providing a mechanism for Dealer to Manually Decode a vehicle. This process utilizes our unique algorithm and processes to properly decode each vehicle in a series of logical steps.

FIG. 20 depicts an example user interface for providing a mechanism for Dealer to Manually Decode a vehicle. This process utilizes our unique algorithm and processes to properly decode each vehicle in a series of logical steps. In particular, FIG. 20 depicts that at step 1: Select proper Trim level for the vehicle.

FIG. 21 depicts an example user interface for providing a mechanism for Dealer to Manually Decode a vehicle. This process utilizes our unique algorithm and processes to properly decode each vehicle in a series of logical steps. In particular, as shown in FIG. 21, at Step 2: Select all installed options and Body Style.

FIG. 22 depicts an example user interface for providing a mechanism for Dealer to Review the current Lease and Finance Rates along with any manufacturer incentive available for every vehicle. This process utilizes our unique algorithms and processes to properly determine the lowest payment available (lease and/or finance). Shows all Lease offers for the Lending sources selected by the dealer. Shows all available Bonus Offers from the Manufacturer

FIG. 23 depicts an example user interface for providing a mechanism for Dealer to Review the current Lease and Finance Rate's along with any manufacturer incentive available for every vehicle. This process utilizes our unique algorithms and processes to properly determine the lowest payment available (lease and/or finance). Shows all available Finance rates from the Lending sources selected by the dealer. Shows all available Bonus Offers from the Manufacturer.

FIG. 24 depicts an example user interface for providing a mechanism for Dealer to Review the current Lease and Finance Rates along with any manufacturer incentive available for every vehicle. This process utilizes our unique algorithms and processes to properly determine the lowest payment available (lease and/or finance). Shows all Purchase offers available from the Manufacturer Shows all available Bonus Offers from the Manufacturer.

FIG. 25 depicts an example user interface for providing a mechanism for Dealer View and Create a Special List. Also allows the Dealer to review the Change Log for their Specials. The option to Edit, Clone and Manage Specials associated with each list is available.

FIG. 26 depicts an example user interface for providing an Edit function modifies the base parameters for a Special List. These parameters include: Name, Image Size, Pause Ads with No Inventory, Alert Notifications, Payment Calculation Setting, and/or Dealer Selector.

FIG. 27 depicts an example user interface for showing a complete list of specials associated with the list selected. A user can easily drag-and-drop to reorder the list according to your preferences and/or filter the List by model.

FIGS. 28-31 depict user interfaces and process flows for editing various data and calculating prices.

Referring to FIGS. 32-36, the SEM Manager will now be described in greater detail hereinbelow. The SEM Manager module provides the Dealer with the “linking” technology to tie each special to the Dealer's Google Adwords Search Marketing campaigns. This linkage is vital to assure that the information displayed in the Google Search Engine matches the information being displayed on the Dealer's website. This process uses a custom algorithms and the Google Adwords API web service to properly update the appropriate Google Text Ads and Remarketing Banners.

The Custom programming follows this process:
1. Validate our credentials
2. Retrieve existing Adwords Campaign information
3. Retrieve existing Text and Image ads
4. Update Text ads
   a. change payment information
   b. enable/disable ads based on inventory availability
5. Update Banner Image ads
   a. change payment information
   b. enable/disable ads based on inventory availability

Having described at least one of the preferred embodiments of the present disclosure with reference to the accompanying drawings, it is to be understood that such embodiments are merely exemplary and that the disclosure is not limited to those precise embodiments, and that various changes, modifications, and adaptations may be effected therein by one skilled in the art without departing from the scope or spirit of the disclosure as defined in the appended claims. The scope of the disclosure, therefore, shall be defined solely by the following claims. Further, it will be apparent to those of skill in the art that numerous changes may be made in such details without departing from the spirit and the principles of the disclosure. It should be appreciated that the present disclosure is capable of being embodied in other forms without departing from its essential characteristics.

What is claimed is:

1. A computerized system for synchronously adjusting pricing displayed in online advertisements, comprising:
a pricing logic module configured to determine a price for an item based on inputs, the pricing logic module configured to receive the information from at least one of an external dealer, manufacturer, and marketing service; and
a deal investigator module configured to receive information from the dealer, the deal investigator module being configured to sort the information received from the dealer and to send the information to the pricing logic module,
the system being configured to synchronously update pricing in online advertisements based on a price determined by the pricing logic module.

2. The system of claim 1, wherein the item is a vehicle, and wherein the deal investigator module is configured to:
import a dealer's vehicle inventory data;
import a manufacturer's finance rates, lease rates and residuals, and rebates and incentives;
identify vehicle characteristics based on a VIN number such that vehicles having predetermined characteristics are sorted into groups.

4. The system of claim 2, wherein the pricing logic module is configured to:
determine a customized price for each vehicle based on predetermined rules;
apply at least one of current finance rates, lease rates, manufacturer rebates and incentives to each vehicle; and
create special payment offers.

5. A server for automatically updating a plurality of ads associating with an ad campaign, the server comprising: a memory and at least one processor operatively coupled to the memory, configured to:
detect a change in an ad from an ad campaign including a plurality of ads; and
in response to detecting the change in the ad, effect the change in all of the ads.

6. The server of claim 5, further comprising:
validating user credentials associating with the ad campaign for an online advertising service hosing the ad campaign.
